(19) United States
(12) Patent Application Publication
(10) Pub. No.: US 2019/0070728 A1
(43) Pub. Date: Mar. 7, 2019

(54) ROBOTIC SYSTEMS AND METHODS FOR OPERATING A ROBOT

(71) Applicant: ABB Schwelz AG, Baden (CH)

(72) Inventors: Steven Wertenberger, Prescott, AZ (US); Thomas Watson, Novi, MI (US); Matthew Sallee, Fort Smith, AR (US); Matthew Henry Churchill, Canton, CT (US)

(21) Appl. No.: 16/122,334

(22) Filed: Sep. 5, 2018

Related U.S. Application Data
(60) Provisional application No. 62/554,466, filed on Sep. 5, 2017.
(60) Provisional application No. 62/554,336, filed on Sep. 5, 2017.

(51) Int. Cl. B25J 9/16

(52) U.S. Cl. CPC B25J 9/1628; B25J 9/1697; B65G 11/00; G05B 2219/45083; G05B 2219/40425

(57) ABSTRACT

A method for operating a robot includes executing program instructions to determine that a robotic control program being executed on a robotic controller to operate the robot has been stopped; executing program instructions to determine whether a cause of the stoppage is a motion supervision error; executing program instructions to request a new target object from a vision system; and executing program instructions to resume normal robotic operation using the robotic control program.

### TECHNICAL FIELD

The present application generally relates to robots, and more particularly, but not exclusively, to robotic systems and methods for operating a robot.

### BACKGROUND

Robotic systems of various types remain an area of interest. Some existing systems have various shortcomings, drawbacks and disadvantages relative to certain applications. For example, in some robotic systems, operator intervention may be reduced, and throughput may be increased. Accordingly, there remains a need for further contributions in this area of technology.

### SUMMARY

A method for operating a robot includes executing program instructions to determine that a robotic control program being executed on a robotic controller to operate the robot has been stopped; executing program instructions to determine whether a cause of the stoppage is a motion supervision error; executing program instructions to request a new target object from a vision system; and executing program instructions to resume normal robotic operation using the robotic control program.

### BRIEF DESCRIPTION OF THE FIGURES

The description herein makes reference to the accompanying drawings wherein like reference numerals refer to like parts throughout the several views, and wherein:

FIG. 1 schematically illustrates some aspects of a non-limiting example of a robotic system for removing objects from a bin and placing the objects on a conveyor in accordance with an embodiment of the present invention.

FIG. 2 schematically illustrates some aspects of a non-limiting example of the robotic system of FIG. 1 in accordance with an embodiment of the present invention.

FIG. 3 illustrates a flowchart depicting some aspects of a non-limiting example of a method for operating a robot, including auto-crash recovery, in accordance with an embodiment of the present invention.

FIGS. 4A and 4B depict some aspects of a non-limiting example of a robot in accordance with an embodiment of the present invention.

FIG. 5 depicts some aspects of a non-limiting example of a computer capable of operating a robot in accordance with an embodiment of the present invention.

FIG. 6 depicts an embodiment of a robot and logistics chute in accordance with an embodiment of the present invention.

FIG. 7 depicts some aspects of a non-limiting example of a robot and logistics chute in accordance with an embodiment of the present invention.

FIG. 8 depicts some aspects of a non-limiting example of a logistics chute in accordance with an embodiment of the present invention.

FIG. 9 depicts some aspects of a non-limiting example of a logistics chute in accordance with an embodiment of the present invention.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

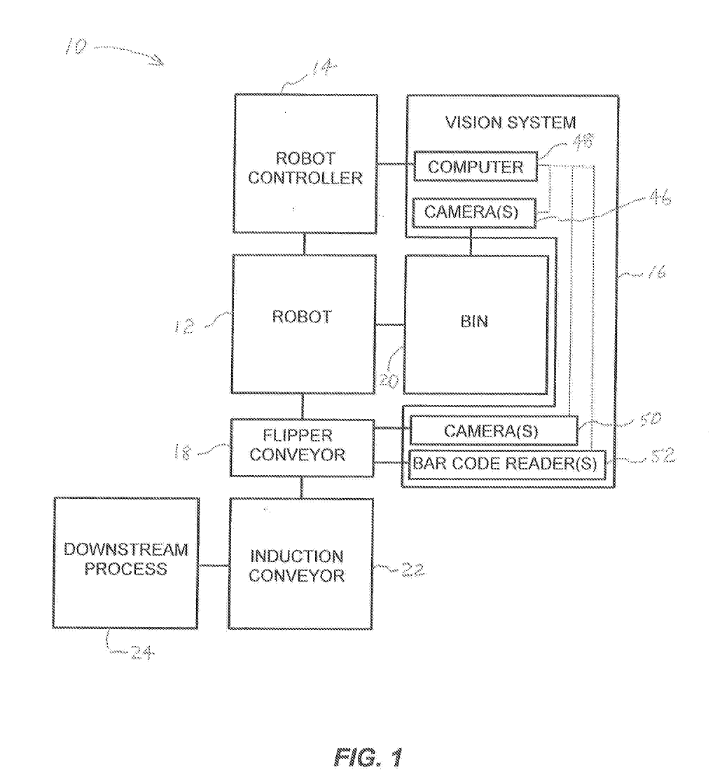

Referring to FIG. 1, some aspects of a non-limiting example of a robotic system 10 in accordance with an embodiment of the present invention is schematically depicted. Robotic system 10 includes a robot 12, a computer-based robotic controller 14, a robotic vision system 16 and a flipper conveyor system 18. In one form, robotic system 10 is operative to retrieve or pick objects, e.g., packages, parts or the like, from a picking bin 20 and place the objects onto an outfeed conveyor, e.g., an induction conveyor 22, for induction into a downstream process 24. The objects are delivered to bin 20 randomly, e.g., by a supply or infeed conveyor (not shown), for picking by robotic system 10. The objects vary in size and shape. Also, the objects vary in orientation in the bin, e.g., due to the random nature of the delivery of the objects to the bin, due to the variations in the size and shape of the objects, and due to the fact that the objects may pile up on top of each other in bin 20 in a random manner.

In one form, controller 14 is microprocessor based and executes program instructions are in the form of software stored in a memory (not shown). However, it is alternatively contemplated that the controller and program instructions may be in the form of any combination of software, firmware and hardware, including state machines, and may reflect the output of discreet devices and/or integrated circuits, which may be co-located at a particular location or distributed across more than one location, including any digital and/or analog devices configured to achieve the same or similar results as a processor-based controller executing software or firmware based instructions or a programmable logic controller.

Robot 12 is constructed to pick the objects up from bin 20 and to deposit the objects onto flipper conveyor system 18 under the direction of robotic controller 14. Flipper conveyor system 18 is operative, under the direction of robotic controller 14, to transfer the objects to induction conveyor 22 in the orientation as deposited by robot 12, or to flip the objects over and then transfer the objects in the flipped-over orientation to induction conveyor 22. For example, in some embodiments, once an object 44 is placed onto flipper conveyor system 18, a determination is made as to whether a particular feature, e.g., a bar code, is found on the top of the object after being placed onto flipper conveyor system 18. If so, flipper conveyor system 18 deposits the object onto induction conveyor 22 in the same orientation as the object was deposited onto flipper conveyor system 18. If not, flipper conveyor system 18 flips the object over and then deposits it onto induction conveyor 22. Induction conveyor 22 is operative to induct the object into a downstream process 24, e.g., to deliver the object to downstream process 24. A non-limiting example of a downstream process 24 is a mail/shipping processing or distribution system, although downstream process 24 may be any industrial, commercial or other process in other embodiments.

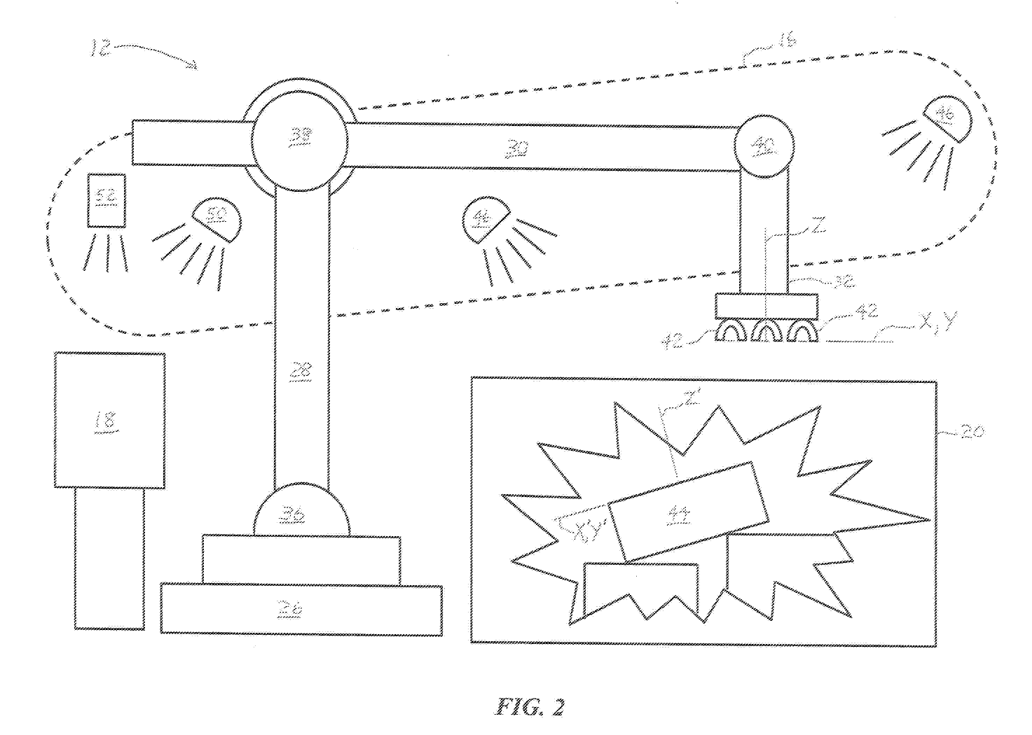

Referring to FIG. 2, robot 12 includes a base 26, a lower arm 28, an upper arm 30 and an end effector 32, e.g., a gripper 34. In one form, robot 12 is a 6-axis robot. In other embodiments, robot 12 may have a greater or lesser number of axes. Lower arm 28 is coupled to base 26 via a shoulder joint system 36. Upper arm 30 is coupled to lower arm 28 via an elbow joint 38. End effector 32 is coupled to upper arm 30 via a wrist joint 40. In one form, end effector 32 is a gripper 34 in the form of a vacuum gripper having a plurality of vacuum powered suction cups 42 configured to pick up objects 44 from bin 20. In one form, the suction cups 42 are arranged in a 3×3 grid. In other embodiments, suction cups 42 may be arranged in other geometric orientations. The number of suction cups may vary with the needs of the application. In other embodiments, other forms of grippers or other types of end effectors may be employed. In one form, the bottoms of suction cups 42 form an XY plane of end effector 32.

At startup, an operator is asked to verify that picking bin 20 is clean and empty. Robot 12 is at a home position at startup. Before objects 44 are placed into bin 20, vision system 16 acquires a background image of bin 20, e.g., using one or more cameras 46, which are constructed to provide 3-dimensional image data, e.g., in the form of a point cloud. The number of cameras may vary with the needs of the application, and thus, various embodiments may have one or any other number of cameras. Cameras 46 may be two or more 2-dimensional cameras used in combination to provide 3-dimensional images, or may be one or more 3-dimensional cameras. The background image of bin 20 without any objects 44 in it is used for background subtraction, and helps to prevent stickers, labels, wear, scratches or other semi-permanent or permanent changes to bin 20 from being mistaken as objects 44. After startup, objects 44 are then randomly deposited into bin 20, e.g., via the infeed conveyor, for subsequent picking by robot 12. Robot 12 executes program instructions to request a target or a new target object from vision system 16, beginning the process of picking up a target object 44 from bin 20

In one form, prior to each pick by robot 12, computer 48 executes program instructions for vision system 16 to take an image, and to subtract the background image, yielding a modified image. In one form, computer 48 is considered a part of vision system 16. Computer 48 is in communication with controller 14. In other embodiments, computer 48 may be a separate computer, e.g., a stand-alone computer, or may be a computer associated with robotic system 12, e.g., may be part of controller 14. In some embodiments, vision system 16 may take a new image after completing a number of picks, followed by subtracting the background image from the new image.

After subtracting the background image, computer 48 executes program instructions to analyze the contents of bin 20 based on the modified image, e.g., prior to each pick. Computer 48 then executes program instructions to select or designate, e.g., randomly, a target object 44 in the bin from the modified image for picking by robot 12. Computer 48 next executes program instructions to analyze the target object 44, e.g., including to determine target data for the target object 44. The target data may include the X′, Y′ and Z′ axes of the target object 44, e.g., of the top-most surface of the designated target object 44, and a score for the target object 44. In some embodiments, computer 48 may also execute program instructions to determine the orientation of the target object 44. Computer 48 provides or transmits the score and the other target data to controller 14.

The score may relate to, for example, a measure of confidence that vision system 16 has designated or selected a good target. For instance, the score may be based on the degree to which the target object has a well-defined surface or shape in the image, e.g., of a predetermined geometry, for example, a rectangular geometry. The score may also be based on a measure of confidence as to how well vision system 16 determined the X′, Y′ and Z′ axes of the target object 44. This may include analyzing as to whether vision system 16 can determine the X′Y′ plane that a planar or non-planar surface of the target object 44, e.g., the X′Y′ plane of a rectangular object's flat or irregular surface. The score may also be based on a measure of confidence as to how well vision system 16 correctly or accurately determined the orientation of the surface, e.g., as indicated by roll or rotation about X, Y and Z axes in an object, target or other coordinate system.

If the score is greater than a predetermined score value, e.g., 50 on a scale of 0-100, or 50%, computer 48 executes program instructions to designate the target object 44 for potential picking from bin 20. Vision system 16 provides, e.g., transmits, target data for the target object 44 to controller 14. In some embodiments, the target data includes the score, and the X, Y and Z axis data for the target object 44, i.e., the X′, Y′ and Z′ axis data for the target object, in preparation for picking the target object 44 from the bin. In some embodiments, vision system 16 also provides orientation data for the target object to controller 14. Before the target is picked up by robot 12, controller 14 executes program instructions to perform a reachability check or determination, e.g., as described herein below. In some embodiments, the reachability check is performed based on the coordinate data for the target object. If the target object 44 passes the reachability check, controller 14 executes program instructions to pick the target object from bin 20 and deposit the target object on flipper conveyor system 18. If the target 44 does not pass the reachability check, controller 14 executes program instructions to request another object 44, e.g., a new target object 44, from vision system 16, and the process of analyzing and scoring the new target object 44 is repeated.

Computer 48 may also execute program instructions to determine if the object is on its side, for example, by determining whether the length of the observed Z-axis dimension of the target object 44 is greater than the lengths of the observed X and Y dimensions of the target object. If the observed Z-axis or vertical dimensional component of the object is greater than the observed X and Y axis or horizontal dimensional components of the object, the target object 44 is determined to be on its side. In some embodiments, robotic system 12 preferably picks objects 44 by gripping the objects 44 on the object 44 X′Y′ plane, which is more readily done when the X′Y′ plane of the object is not vertical, and more preferably is horizontal or within some desired angle of the horizontal.

If the target object 44 is on its side, a reachability check is also performed. If the target 44 does not pass the reachability check, controller 14 executes program instructions to request another object 44, e.g., a new target object 44, from vision system 16, and the process of analyzing and scoring the new target object 44 is repeated. Otherwise, if the target object 44 passes the reachability check, robot controller 14 executes program instructions to pick up the target object 44 and move or toss it to change its orientation, e.g., so that it is no longer resting on its side or no longer resting predominantly on its side. For example, the move or toss is performed to make the object 44 land or come to rest predominantly on the surface having the largest dimensions or area or surface, e.g., a top or bottom surface.

If the score is less than 50%, another, e.g., new, target object 44 is designated, e.g., randomly, and the process of analyzing and scoring the new target object 44 is repeated. In some embodiments, a new image of bin 20 with objects 44 disposed therein is taken (and the background subtracted) after determining a score of less than 50% for a previous target object and prior to designating another, new, potential target object. In other embodiments, the same image may be used as was used for the previous target object.

If the score is less than 50% a predetermined number, N, of times, in a row, i.e., for N different designated target objects in a row, controller 14 executes program instructions to perform a stir routine on the objects in bin 20, e.g., by stirring, shaking, agitating or tossing objects 44 about in bin 20. In one form, N=3. In other embodiments, N may be any value suitable for the particular application. If the stir routine includes tossing or moving the target object 44, controller 14 executes program instructions to perform a reachability check on the target object 44 prior to picking up the target object 44 for tossing.

Thus, if a target object 44 has a score of 50% or greater and if the target object 44 was not determined to be on its side, a reachability check or determination is performed. If the object passes the reachability check, i.e., is determined to be reachable, controller 14 executes program instructions to pick the target object 44 from bin 20, and deposit the target object onto flipper conveyor system 18. A vision system, e.g., vision system 16 then executes program instructions, e.g., using computer 48, to determine, using one or more cameras 50, whether more than one target object 44 was inadvertently picked from bin 20 and placed onto flipper conveyor system 18. In addition, one or more bar code readers 52 are used to determine whether a bar code is presented on the top of the target object 44 that is on flipper conveyor system 18. If so, flipper conveyor system 18 moves in one direction to deposit the target object 44 onto induction conveyor 22 in the same orientation as it was placed on flipper conveyor system 18. If not, flipper conveyor system 18 moves in another direction to flip the target object 44 over, and then deposits the flipped target object 44 onto induction conveyor 22.

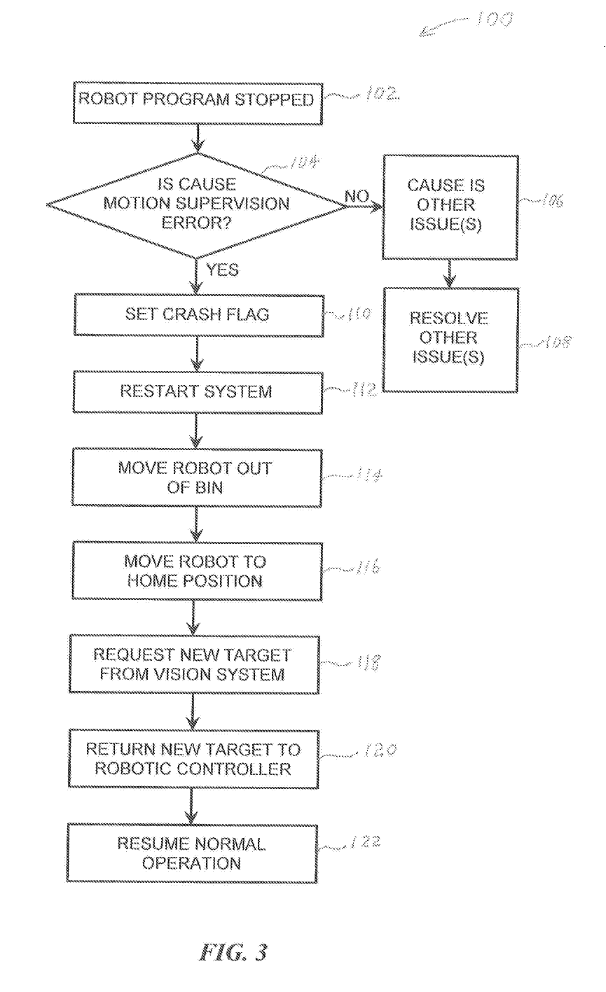

Referring to FIG. 3, in some situations, an object 44 may be deposited into bin 20, e.g., by an infeed conveyor, after robot 12 begins moving to pick a target object 44 from bin 20, for example, without robotic controller 14 knowing that the object 44 has been so placed. For example, a new object 44 may be dropped into bin 20 after an image of bin 20 was taken, but before robot 12 picks the object from the bin. The new object may interfere with the movement of robot 12 during the picking operation, or may cause a shift in the other objects 44 located in bin 20 such that one of the other objects 44 interferes with robot 20. Because the new object 44 was dropped into bin 20 after the image was taken for the current picking operation, or after the target object 44 was designated (and in some cases, potentially before the target object 44 was analyzed and scored, and/or the reachability check performed), robot 12 is not aware of the new object 44 or of the shift in other objects 44 in bin 20. Robot 12 may thus collide with the new object 44 or one of the other objects 44 while moving to pick up the target object 44.

FIG. 3 illustrates some aspects of a non-limiting example of a method of operating robot 12 that includes a method for performing auto-crash recovery in accordance with an embodiment of the present invention. For example, with typical robotic systems, once a collision occurs, e.g., where the robot collides unintentionally with an object, the robot's motion is immediately stopped or potentially reversed and then stopped as a matter of safety, to prevent damage to a person and/or object and/or the robot. In many cases, this includes stoppage of the robot's control algorithms. This stoppage may be referred to as a crash, e.g., of the robot's control algorithms, and in conventional robotic systems, requires operator involvement or intervention to rectify the situation. The auto-crash recovery method of FIG. 3 functions to direct the operations of controller 14 and robot 12 after a collision, and to recover operation of controller 14 and robot 12 after the collision, without requiring operator involvement or intervention, e.g., depending upon the cause of the crash in some embodiments.

Some aspects of the auto-crash recovery procedure are illustrated with a flowchart 100 of FIG. 3. Initially, prior to block 102 in flowchart 100, controller 14 is executing instructions of a robotic control program to perform an action with robot 12, e.g., to pick a target object from bin 20. In one form, a collision of robot 12 occurs while end effector 32 is in bin 20 attempting to pick up a target object from bin 20. Controller 14 executes program instructions to implement the method of blocks 102, 104 and 110 to 122 to recover the robot and resume normal operation without human involvement or intervention.

At block 102, controller 14 executes program instructions to determine that the robot 12 control program executing on controller 14 is stopped. In some embodiments, controller 14 executes program instructions to stop the robot control program. For example, the robot control program may be stopped by controller 14 due to a collision of robot 12. Controller 14 may execute program instructions to detect the collision, for example, prior to stopping execution of the robot control program, e.g., by monitoring the torque for each robot 12 axis. When the torque exceeds an expected value by a predetermined margin or tolerance value, e.g., an expected value for the particular operation being performed by robot 12, controller 14 determines that a collision has taken place. In some embodiments, the torque determination may be made, for example, based on torque sensors for one or more rotational axes of robot 12, e.g., one or more of the 6 axes of robot 12, based on drive motor current, and/or based on other measurements related to robot 12 motion, e.g., including force sensors or motor/winding temperature in some embodiments.

At block 104, controller 14 executes program instructions to determine whether the cause of the stoppage is a motion supervision error. A collision of robot 12 with an intervening person, object or other physical structure is an example of a motion supervision error. If not, process flow proceeds to block 106, where it is determined that the cause of the stoppage is due to other issues, e.g., unrelated to a motion supervision error. Process flow then proceeds to block 108, wherein the other issue(s) is resolved, and measures are taken to resume normal operation of controller 14 and robot 12. If the cause is determined to be a motion supervision error, process flow proceeds to block 110.

At block 110, controller 14 executes program instructions to set a crash flag. In some embodiments, the crash flag is set in response to determining that the cause of the stoppage is a collision of robot 12, or in some embodiments, in response to detecting that a collision has occurred. A set crash flag indicates to programs and subroutines being executed on controller 14 that a collision of robot 12 has occurred. Process flow then proceeds to block 112.

At block 112, controller 14 executes program instructions to restart the robot. In some embodiments, this may include restarting the robot control program execution on controller 14. In some embodiments, the set crash flag is read by controller 14, and the next actions are performed based on the crash flag having been set.

At block 114, controller 14 executes program instructions to direct robot 12 to move out of bin 20.

At block 116, controller 14 executes program instructions to direct robot 12 to move to a home position.

At block 118, controller 14 executes program instructions to request a new target object 44 from vision system 16.

At block 120, vision system 16 executes program instructions to return a new target object 44 to controller 14 in response to the request at block 118. The target object has been analyzed and scored, and the target data sent to controller 114.

At block 122, controller 14 executes program instructions to resume normal operation of robot 12 under the direction of the robot control program.

By executing an auto-crash recovery program to recover a robot from a collision and then resume normal robotic operation, e.g., as described hereinabove, embodiments of the present invention reduce the need for operator involvement or invention, and increase throughput of the robotic cell.

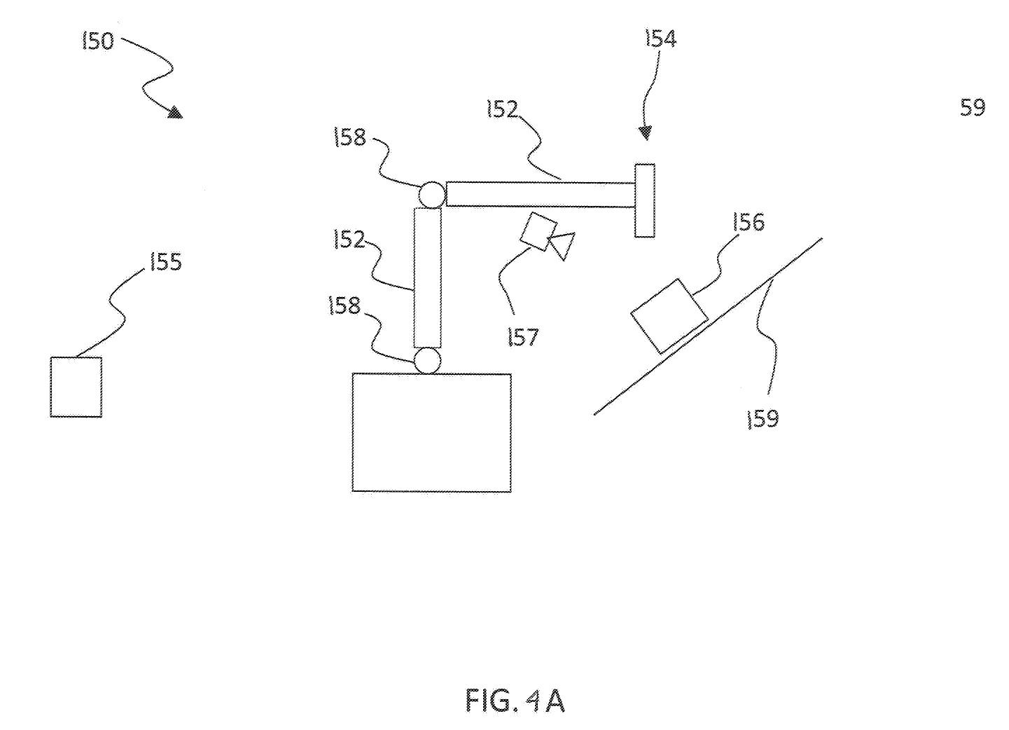

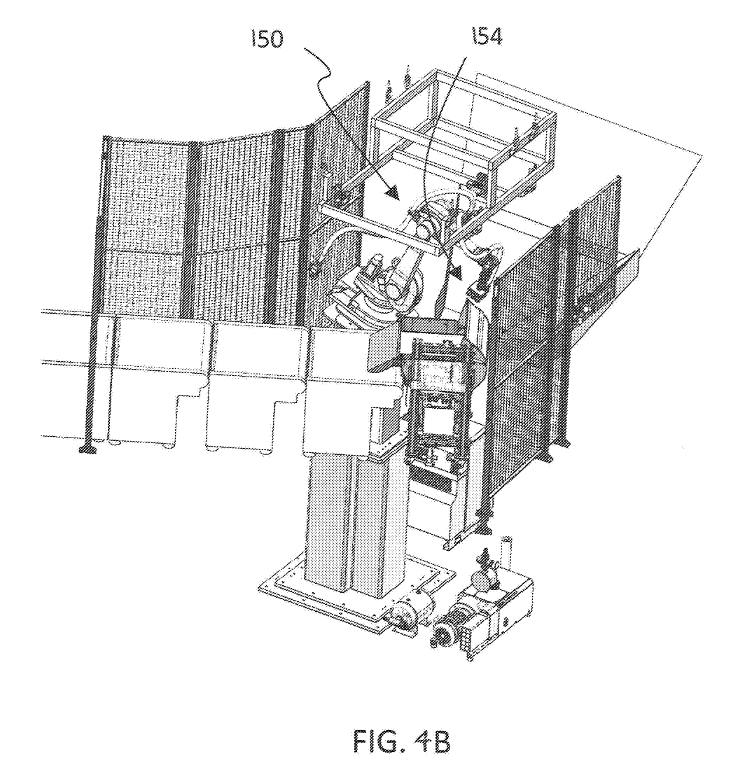

With reference to FIGS. 4A and 4B, a schematic of a robot 150 is shown which includes a number of moveable robot components 152 along with an effector 154 useful to retrieve a target 156. The target 156 can take any variety of forms, and in one embodiment the robot 150 and effector 154 are used for gripping mixed logistics secondary packages during robotic singulation from a randomized live chute feed. For example, the target 156 can include corrugated shipping cases, paperboard cases and envelopes, Jiffy mailing envelopes, poly flex mailers, and polymer film pouches that might be located on a logistics chute 159. The robot 150 can be mounted upon a stationary base as illustrated in FIGS. 4A and 4B, but other forms are also contemplated. The robot components 152 can take any variety of forms such as arms, links, beams, etc which can be used to position the effector 154. The robot 150 can include any number of moveable components 152 which can take on different sizes, shapes, and other features. The components 152, furthermore, can be interconnected with one another through any variety of useful mechanisms such as links and gears 158, to set forth just two examples. The components 152 can be actuated via any suitable device such as electric actuators, pneumatic or hydraulic pistons, etc. The effector 154 can take any variety of forms such as a gripper, suction effector, belt, etc. Further embodiments of the gripper 154 are described further below.

The robot 150 can be controlled via a controller 155 which can be local to the robot 150, or stationed at a remote location. In one form, controller 155 is microprocessor based and executes program instructions are in the form of software stored in a memory (not shown). However, it is alternatively contemplated that the controller and program instructions may be in the form of any combination of software, firmware and hardware, including state machines, and may reflect the output of discreet devices and/or integrated circuits, which may be co-located at a particular location or distributed across more than one location, including any digital and/or analog devices configured to achieve the same or similar results as a processor-based controller executing software or firmware based instructions or a programmable logic controller.

A position finder 157 (referred to as a vision system in some embodiments) can be used to locate the target 156. The position finder 157 can be based upon a camera, scanner, or similar device that is capable of capturing a signal useful for producing a point cloud representative of locations on an object of interest (e.g. target 156). The camera, scanner, or like device is used to capture any variety of signals such as electromagnetic radiation (e.g. visible light), sound, etc., that is reflected or passes through an object (e.g. target 156 and/or robot 154). The position finder 157 can be hand held or retained through any mechanism, whether static or moving. The position finder 157 can be used in conjunction with a source that emits such signals (e.g., overhead lights, laser, x-ray machine, audible or non-audible speaker, etc.) or utilize ambient reflected signals such as may occur through an object illuminated by sunlight. The detection/capture of such a signal can be used to determine the location of one or more aspects of an object of interest and can be accomplished through any number of devices such as a charge-coupled device, microphone, etc. Detecting the locations of various features permits the creation of a point cloud which can be referenced to an arbitrary coordinate system, usually defined relative to the position finder itself. Such a point cloud can be determined through use of the computer 160 as will be described further below.

A few non-limiting examples of a position finders 157 include non-contact 3D scanners, non-contact passive scanners, stereoscopic systems, photometric scanners, silhouette scanners, 3-D cameras, moving 2-D cameras, etc. For ease of description, and to highlight just two possible position finders (any suitable for creation of point clouds are acceptable herein), reference will be made below to either “camera” or “scanner”, though no limitation is hereby intended regarding the suitability of any other possible position finder 157 as suggested above in any of the disclosed embodiments. Thus, any mention of “camera” or “scanner” with respect to any specific embodiment will be appreciated to also apply to any of the other types of position finders 157 unless inherently or explicitly prohibited to the contrary.

As used herein, the term “position finder” can include a single sensor that receives a position information signal (e.g. reflected electromagnetic radiation, etc.) and/or can include a larger system of sensors, lenses, housing, cabling, etc. No limitation is hereby intended that a “position finder” is limited to a single discrete component unless expressly intended to the contrary.

The position finder 157 can capture an “image” of the scene useful in determining the position of various features within the scene. Such an “image” can include any different data type associated with the various types of position finders. For example, the “image” can be a visible photo image of the scene, laser scan data, etc. in any of the possible data formats (.jpeg, .mpeg, .mov, etc.). The data formats, or data derived from the formats, can be transformed into any format or data type useful to implement and/or perform the various embodiments described herein. The position data associated with the various features is any type of data useful to either directly express distance or infer distance with subsequent processing. For example, position data can be a visual scene captured by a camera and operated upon by subsequent algorithm of the controller 155 to determine position information.

The position information of each of the features is used by the controller 155 or other suitable device to formulate a point cloud associated with the various features, each point representing a feature or component of an object within the scene. The point cloud is used in later processing to determine relative positioning of objects in the scene, and to identify features of the scene through object recognition.

As suggested above, the camera 157 can be hand held, but other variations are also contemplated herein. In one non-limiting embodiment the camera 157 can be located on the robot 150, for example mounted in conjunction with a base of an arm, or any other suitable location. In other embodiments, however, the camera 157 can be located remote from the robot 150, such as but not limited to a wall of a workspace in which the robot 150 is also located.

Devices described herein provide for gripping an array of package containment media during high speed robotic transport which can utilizes a coupled 3-dimensional perception system (e.g. vision system described above) for package identification and location. As will be described further below, a normal axis compliant device prevents robot collisions when picking packages from a dynamic environment while a surface level compliant device allows for contoured surface gripping. Also described below is the gripping interface technique, along with a vacuum source and vacuum distribution configuration to permit high speed handling of a wide range of packaging containment media typically seen in logistics distribution processes.

FIG. 4B depicts one embodiment of the robot 150 having the effector 154 which is disposed within a workspace.

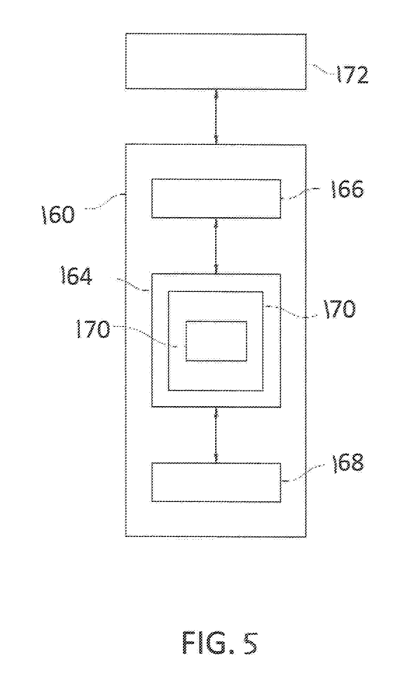

Turning now to FIG. 5, and with continued reference to FIGS. 4A and 4B, a schematic diagram is depicted of a computer 160 suitable to host the controller 155 for operating the robot 150. Computer 160 includes a processing device 164, an input/output device 166, memory 168, and operating logic 170. Furthermore, computer 160 can be configured to communicate with one or more external devices 172.

The input/output device 166 may be any type of device that allows the computer 160 to communicate with the external device 172. For example, the input/output device may be a network adapter, network card, or a port (e.g., a USB port, serial port, parallel port, VGA, DVI, HDMI, FireWire, CAT 5, or any other type of port). The input/output device 166 may be comprised of hardware, software, and/or firmware. It is contemplated that the input/output device 166 includes more than one of these adapters, cards, or ports.

The external device 172 may be any type of device that allows data to be inputted or outputted from the computer 160. In one non-limiting example the external device 172 is any of the sensors 157 and 159. To set forth just a few additional non-limiting examples, the external device 172 may be another computer, a server, a printer, a display, an alarm, an illuminated indicator, a keyboard, a mouse, mouse button, or a touch screen display. Furthermore, it is contemplated that the external device 172 may be integrated into the computer 160. For example, the computer 160 may be a smartphone, a laptop computer, or a tablet computer. It is further contemplated that there may be more than one external device in communication with the computer 160. The external device can be co-located with the computer 160 or alternatively located remotely from the computer.

Processing device 164 can be of a programmable type, a dedicated, hardwired state machine, or a combination of these; and can further include multiple processors, Arithmetic-Logic Units (ALUs), Central Processing Units (CPUs), or the like. For forms of processing device 164 with multiple processing units, distributed, pipelined, and/or parallel processing can be utilized as appropriate. Processing device 164 may be dedicated to performance of just the operations described herein or may be utilized in one or more additional applications. In the depicted form, processing device 164 is of a programmable variety that executes algorithms and processes data in accordance with operating logic 170 as defined by programming instructions (such as software or firmware) stored in memory 168. Alternatively or additionally, operating logic 170 for processing device 164 is at least partially defined by hardwired logic or other hardware. Processing device 164 can be comprised of one or more components of any type suitable to process the signals received from input/output device 166 or elsewhere, and provide desired output signals. Such components may include digital circuitry, analog circuitry, or a combination of both.

Memory 168 may be of one or more types, such as a solid-state variety, electromagnetic variety, optical variety, or a combination of these forms. Furthermore, memory 168 can be volatile, nonvolatile, or a mixture of these types, and some or all of memory 168 can be of a portable variety, such as a disk, tape, memory stick, cartridge, or the like. In addition, memory 168 can store data that is manipulated by the operating logic 170 of processing device 164, such as data representative of signals received from and/or sent to input/output device 166 in addition to or in lieu of storing programming instructions defining operating logic 170, just to name one example. As shown in FIG. 5, memory 168 may be included with processing device 164 and/or coupled to the processing device 164.

The operating logic 170 can include the algorithms and steps of the controller, whether the controller includes the entire suite of algorithms necessary to effect movement and actions of the robot 150, or whether the controller includes just those necessary to receive data from the camera 157, determine a point cloud, utilize object recognition (discussed further below), and resolve position of the objects relative to a frame of reference keyed to the robot 150. The operating logic can be saved in a memory device whether of the volatile or nonvolatile type, and can be expressed in any suitable type such as but not limited to source code, object code, and machine code.

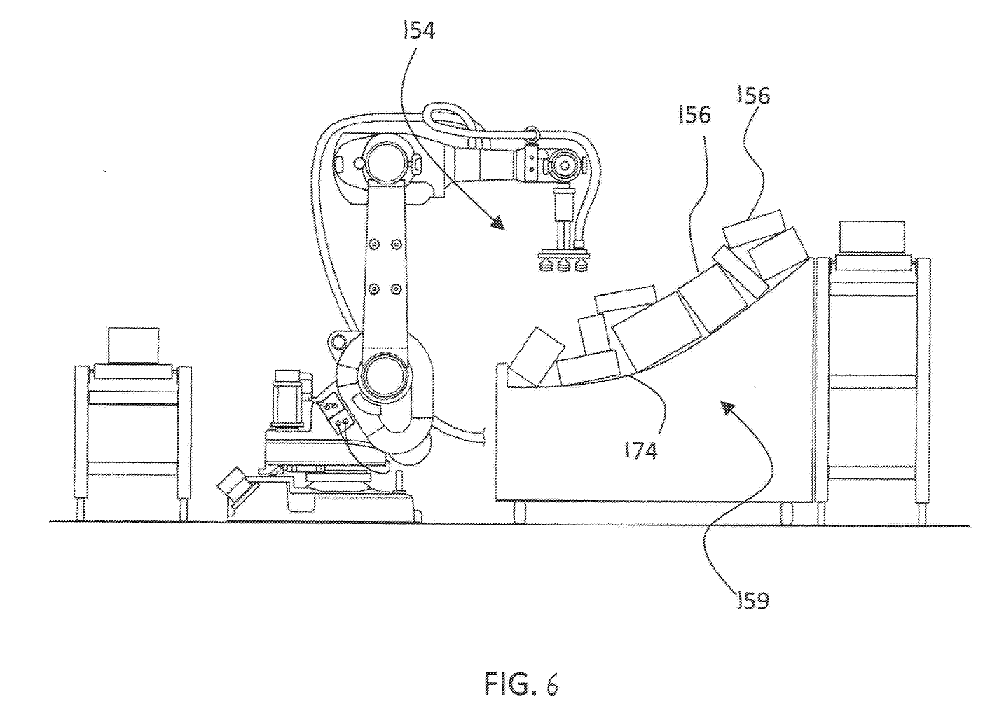

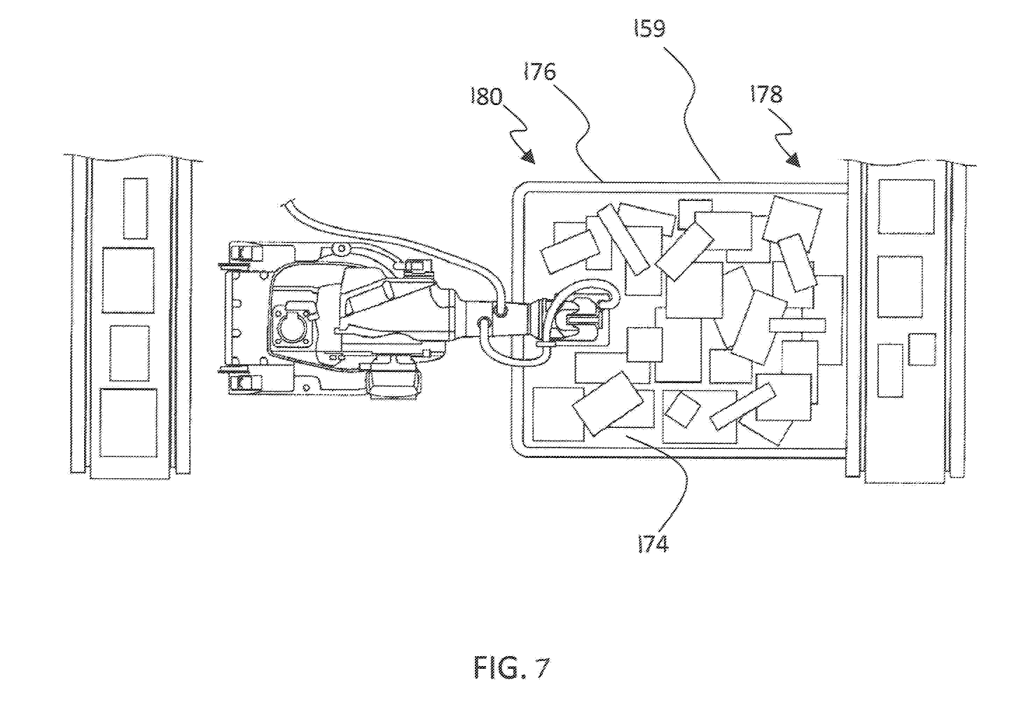

FIGS. 6 and 7 illustrates the robot 150 as it interacts with packages 156 placed onto one embodiment of the chute 159. The chute 159 is generally sloped downward to encourage packages 156 to feed toward the bottom as the robot 150 identifies and removes packages 156 from the chute 159 for subsequent placement on a conveyor/feeder/bin/etc. The chute 159 generally includes a base 174 and sides 176 which act to contain the packages 156 as the robot seeks to remove them from the chute 159. The bottom 174 can be curved as in the illustrated embodiment of FIG. 6, but other embodiments can include a flat bottom. Although the chute 159 is shown from above in FIG. 7 as rectangular in shape, other shapes are also contemplated.

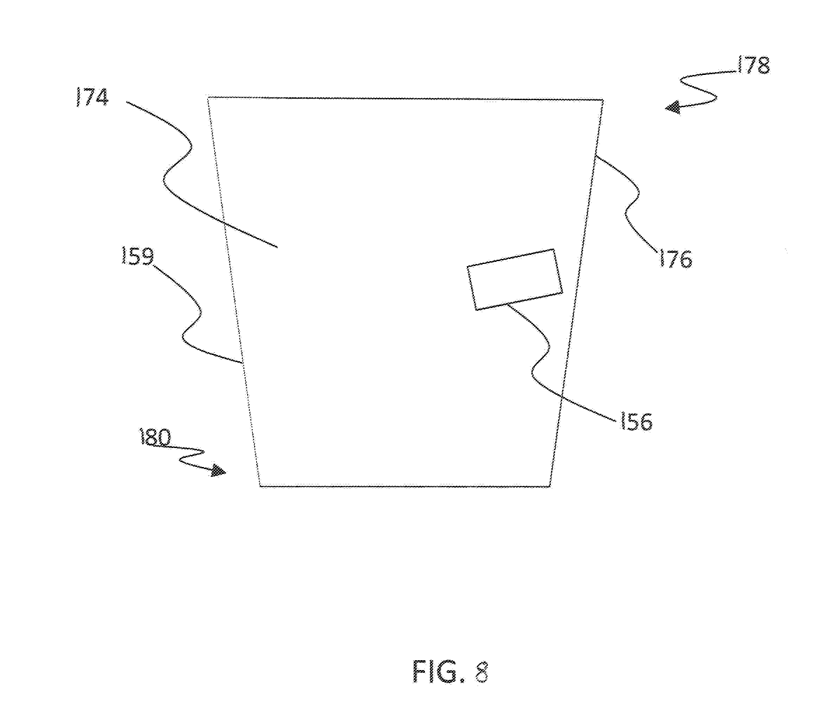

FIG. 8 depicts an alternative embodiment to those shown in FIG. 7. Although the embodiment in FIG. 8 can include either a flat or curved base 174, the sides 176 are angled as they descend from a top 178 of the chute 159 to the bottom 180. Such a configuration can provide for a cone-like shape in the chute 159 which in some applications assists in funneling packages 156 toward the bottom under the influence of gravity and during the course of operation of the robot 150 as it sorts packages.

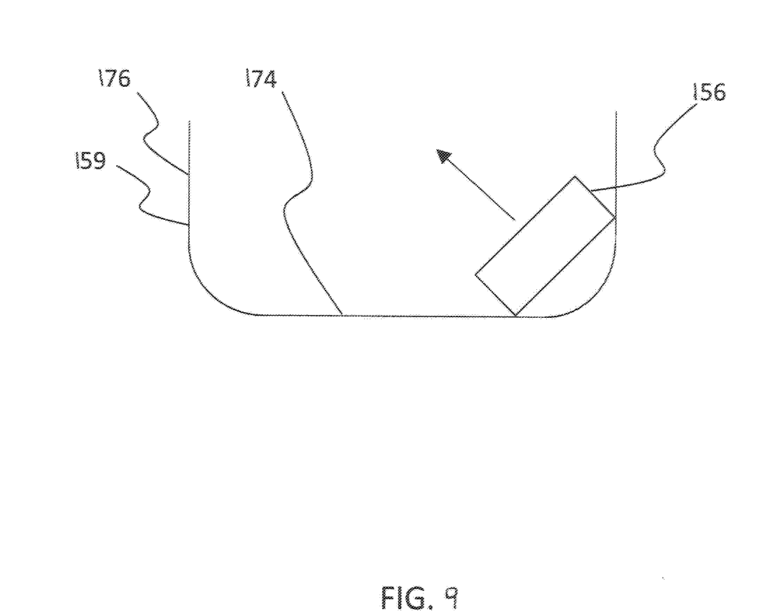

FIG. 9 depicts a cross section of the chute 159 looking along the direction of the base 174 as it extends between the top 178 and bottom 180. The embodiment depicted in FIG. 9 can include the base 174 having any suitable shape (e.g. a flat or curved base as depicted above), and can include any suitable configuration (e.g. a rectangular shape or cone-like shape as seen above in FIGS. 7 and 8).

FIG. 9 illustrates the base 174 and sides 176 forming a rounded corner between the two. Such rounded corner can be used to encourage packages 156 at the edges to ride up the wall and present themselves for better picking by pointing back to the middle of the chute, which can be seen as illustrated by the arrow 182. This is in contrast to a chute 159 having a relatively sharp corner in which the packages would be wedged against the side 176 as packages fall under the influence of gravity on the chute 159 without presenting itself toward the center as is the case in FIG. 9. The curvatures can be along a constant radius of curvature from the base 174 to the sides 176. In other forms, the curvature can be a compound curvature composed of multiple distinct radii of curvature. In still alternative and/or additional embodiments, one or more portions of the curvature from the base 174 to the sides 176 can have a constantly varying curvature with multiple instantaneous radii of curvature. Various curvatures are contemplated, which in some applications may depend on the range of sizes of packages 156. In one non-limiting form the curvature includes a constant radius of curvature that can range from 3-4 inches. In other forms the constant radius of curvature can be 3-5 inches, and 3-6 in others. To set forth just a few non-limiting examples, the radius of curvature can be 2″, 3″, 4″, 5″, or 6″, or any value therebetween, such as but not limited to any ½″ increment. The lower limit of the ranges described above can extend below 3 inches to 2 or 1 inches. In short, any variety of radii are contemplated.

Embodiments of the present invention include a method for operating a robot, comprising: executing program instructions to determine that a robotic control program being executed on a robotic controller to operate the robot has been stopped; executing program instructions to determine whether a cause of the stoppage is a motion supervision error; executing program instructions to request a new target object from a vision system; and executing program instructions to resume normal robotic operation using the robotic control program.

In a refinement, the motion supervision error is a collision of the robot.

In another refinement, the method further comprises executing program instructions to set a crash flag responsive to a determination that the cause of the stoppage is a collision of the robot.

In yet another refinement, the method further comprises executing program instructions to restart the robot after the detection of the collision of the robot.

In still another refinement, the collision occurred in a picking bin, further comprising executing program instructions to move the robot out of a bin prior to resuming normal operation.

In yet still another refinement, the method further comprises executing program instructions to move the robot to a home position prior to resuming normal operation.

In a further refinement, the method further comprises executing program instructions to direct the vision system to return the new target object to the robotic controller in response to executing the program instructions to request the new target object.

In a yet further refinement, the program instructions to determine that the robotic control program has been stopped, determine whether the cause of the stoppage is the motion supervision error, request the new target object from the vision system, and resume the normal robotic operation are executed without human intervention.

In a yet still further refinement, the executing program instructions to request a new target object from a vision system and the executing program instructions to resume normal robotic operation using the robotic control program are performed responsive to a determination that the cause of the stoppage is the motion supervision error.

Embodiments of the present invention include a method for operating a robot, comprising: executing program instructions of a robotic control program to perform an action with the robot; executing program instructions to detect a collision of the robot; executing program instructions to stop the execution of the robot control program; executing program instructions to set a crash flag; executing program instructions to request a new target object from a vision system; and executing program instructions to resume normal robotic operation using the robotic control program.

In a refinement, the method further comprises executing program instructions to restart the robotic control program after the detection of the collision of the robot.

In another refinement, the collision occurred in a picking bin, further comprising executing program instructions to move the robot out of a bin prior to resuming normal operation.

In yet another refinement, the method further comprises executing program instructions to move the robot to a home position prior to resuming normal operation.

In still another refinement, the method further comprises executing program instructions to direct the vision system to return the new target object to the robotic controller in response to executing the program instructions to request the new target object.

In yet still another refinement, the program instructions to detect a collision of the robot; stop the execution of the robot control program; set a crash flag; request a new target object from a vision system; and resume normal robotic operation using the robotic control program are all executed without human intervention.

In a further refinement, the executing program instructions to request a new target object from a vision system and the executing program instructions to resume normal robotic operation using the robotic control program are performed responsive to the crash flag being set.

Embodiments of the present invention include an apparatus comprising: a logistics chute that extends from a top portion to a bottom portion and structured to permit packages to be gravity fed along a base of the chute from the top portion to the bottom portion, the logistics chute including a first lateral side and a second lateral side that bound the logistics chute, the logistics chute further including a first rounded corner that extends from the base to the first side.

In a refinement, the apparatus further includes a second rounded corner that extends from the base to the second side.

In another refinement, the first rounded corner includes a single constant radius of curvature.

In yet another refinement, the second rounded corner includes a single constant radius of curvature.

In still another refinement, the first rounded corner includes a radius of curvature between 3-5 inches.

In yet still another refinement, the second rounded corner includes a radius of curvature between 3-5 inches.

In a further refinement, the base is flat.

In a yet further refinement, the base is curved.

In a still further refinement, the first lateral side and second lateral side are configured to converge toward one another as the respective first lateral side and second lateral side extend from the top portion to the bottom portion of the logistics chute.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. A method for operating a robot, comprising:
executing program instructions to determine that a robotic control program being executed on a robotic controller to operate the robot has been stopped;
executing program instructions to determine whether a cause of the stoppage is a motion supervision error;
executing program instructions to request a new target object from a vision system; and
executing program instructions to resume normal robotic operation using the robotic control program.

2. The method of claim 1, wherein the motion supervision error is a collision of the robot.

3. The method of claim 2, further comprising executing program instructions to set a crash flag responsive to a determination that the cause of the stoppage is a collision of the robot.

4. The method of claim 3, further comprising executing program instructions to restart the robot after the detection of the collision of the robot.

5. The method of claim 2, wherein the collision occurred in a picking bin, further comprising executing program instructions to move the robot out of a bin prior to resuming normal operation.

6. The method of claim 5, further comprising executing program instructions to move the robot to a home position prior to resuming normal operation.

7. The method of claim 2, further comprising executing program instructions to direct the vision system to return the new target object to the robotic controller in response to executing the program instructions to request the new target object.

8. The method of claim 1, wherein the program instructions to determine that the robotic control program has been stopped, determine whether the cause of the stoppage is the motion supervision error, request the new target object from the vision system, and resume the normal robotic operation are executed without human intervention.

9. The method of claim 1, wherein the executing program instructions to request a new target object from a vision system and the executing program instructions to resume normal robotic operation using the robotic control program are performed responsive to a determination that the cause of the stoppage is the motion supervision error.

10. A method for operating a robot, comprising:
executing program instructions of a robotic control program to perform an action with the robot;
executing program instructions to detect a collision of the robot;
executing program instructions to stop the execution of the robot control program;
executing program instructions to set a crash flag;
executing program instructions to request a new target object from a vision system; and
executing program instructions to resume normal robotic operation using the robotic control program.

11. The method of claim 10, further comprising executing program instructions to restart the robotic control program after the detection of the collision of the robot.

12. The method of claim 10, wherein the collision occurred in a picking bin, further comprising executing program instructions to move the robot out of a bin prior to resuming normal operation.

13. The method of claim 12, further comprising executing program instructions to move the robot to a home position prior to resuming normal operation.

14. The method of claim 10, further comprising executing program instructions to direct the vision system to return the new target object to the robotic controller in response to executing the program instructions to request the new target object.

15. The method of claim 10, wherein the program instructions to detect a collision of the robot; stop the execution of the robot control program; set a crash flag; request a new target object from a vision system; and resume normal robotic operation using the robotic control program are all executed without human intervention.

16. The method of claim 10, wherein the executing program instructions to request a new target object from a vision system and the executing program instructions to resume normal robotic operation using the robotic control program are performed responsive to the crash flag being set.

17. An apparatus comprising: a logistics chute that extends from a top portion to a bottom portion and structured to permit packages to be gravity fed along a base of the chute from the top portion to the bottom portion, the logistics chute including a first lateral side and a second lateral side that bound the logistics chute, the logistics chute further including a first rounded corner that extends from the base to the first side.

18. The apparatus of claim 17, which further includes a second rounded corner that extends from the base to the second side.

19. The apparatus of claim 17, wherein the first rounded corner includes a single constant radius of curvature.

20. The apparatus of claim 17, wherein the second rounded corner includes a single constant radius of curvature.

21. The apparatus of claim 17, wherein the first rounded corner includes a radius of curvature between 3-5 inches.

22. The apparatus of claim 17, wherein the second rounded corner includes a radius of curvature between 3-5 inches.

23. The apparatus of claim 17, wherein the base is flat.

24. The apparatus of claim 17, wherein the base is curved.

25. The apparatus of claim 17, wherein the first lateral side and second lateral side are configured to converge toward one another as the respective first lateral side and second lateral side extend from the top portion to the bottom portion of the logistics chute.
